(19) United States
(12) Patent Application Publication
(10) Pub. No.: US 2017/0337260 A1
(43) Pub. Date: Nov. 23, 2017

(54) METHOD AND DEVICE FOR STORING DATA

(71) Applicant: GUANGZHOU SHENMA MOBILE INFORMATION TECHNOLOGY CO. LTD., GUANGZHOU CITY (CN)

(72) Inventors: JIEXIONG WANG, GUANGZHOU (CN); YANG YANG, GUANGZHOU (CN); WEIJUN FU, GUANGZHOU (CN); YINING CHEN, GUANGZHOU (CN)

(21) Appl. No.: 15/671,260

(22) Filed: Aug. 8, 2017

Related U.S. Application Data
(63) Continuation of application No. PCT/CN2016/070323, filed on Jan. 6, 2016.

(30) Foreign Application Priority Data
Feb. 13, 2015 (CN) 201510083879.5

(51) Int. Cl. G06F 17/30; G06F 3/06

(52) U.S. Cl. CPC G06F 17/30604; G06F 17/30722; G06F 3/0608; G06F 17/30598

(57) ABSTRACT

The present application discloses a method and a device for storing data. According to the method, entity-related data associated with entities is acquired from a web page, wherein the entity-related data comprises entity data representing the entities, entity attribute data describing attributes of the entities, and inter-entity relationship data describing a relationship between two entities. The entity data and the respective entity attribute data are stored into an entity database in an associated manner. The inter-entity relationship data is stored into a relationship database. Accordingly, the entity data associated with a single entity and the attribute data thereof are collectively stored in the entity database, and the inter-entity relationship data involved with two entities is separately stored in the relationship database. This data storage method avoids data storage redundancy and query aggregation, saves storage space and is convenient for query. In addition, the problem that a large amount of attribute information needs to be aggregated during on-line query is avoided, thus saving query time and improving user experience.

### CROSS REFERENCE TO RELATED APPLICATIONS

This application is a continuation application of International Application No. PCT/CN2016/070323, filed Jan. 6, 2016, which claims the priority and benefit of Chinese patent application entitled “Method and Device for Storing Data” filed with the Chinese Patent Office on Feb. 13, 2015 with the application No. 201510083879.5. Both of the above referenced applications are incorporated herein by reference in their entirety.

### TECHNICAL FIELD

The present invention relates to the field of Internet, and especially to a method and a device for storing data.

### BACKGROUND ART

At present, in a web search and query, query words from a user may involve a large amount of precise intentions, which cannot be satisfied via web page granularity, but an answer needs to be directly returned in the search. For example, if “the Height of Dehua Liu” is searched, it is expected to return “174 CM”; if “stars whose height is more than 180 cm” is searched, a result expected to be returned is a list of stars, whose height is within the specified range, such as “Juji Gu, Shaoqiu Zheng”; and if “Eight Great Prose Masters of the Tang and Song Dynasties” is searched, it is expected to return “Zongyuan Liu” et al.

However, in traditional search products, web page links are returned as search results by comparing the degree of text matching between the query words from the user and included web pages, and a correlation algorithm is used to ensure that the returned results satisfy the user's search intention. However, the user can only obtain a wanted answer by connecting to and reading the found web pages.

Therefore, there is a need for a method and a device for storing data which not only save storage space but are also convenient for query.

### SUMMARY

The present disclosure provides a method and a device for storing data which not only save storage space but are also convenient for query.

According to one aspect of the present disclosure, a method for storing data is provided, comprising steps of:

acquiring entity-related data associated with entities from a web page, the entity-related data comprising entity data representing the entities, entity attribute data describing attributes of the entities, and inter-entity relationship data describing a relationship between two entities;

storing the entity data and the respective entity attribute data into an entity database in an associated manner; and

storing the inter-entity relationship data into a relationship database.

Accordingly, the entity data and the attribute data of the entity are collectively stored in the entity database, and the inter-entity relationship data is separately stored in the relationship database. This data storage method avoids data storage redundancy and query aggregation, saves storage space and is convenient for query. Furthermore, the entity data field may correspond to one or more variable attribute field entities, so that the attribute data information about the same entity is integrated and stored, thus avoiding the problem that a large amount of attribute information needs to be aggregated during on-line query, nor requiring a large amount of filtering and data combination and splicing operations for returned query results, thereby significantly saving query time, and further improving user experience.

Preferably, a record for one entity in the entity database may comprise an entity data field and one or more variable attribute fields associated with the entity data field, wherein the entity data is stored into the entity data field, and the entity attribute data is stored into the variable attribute field.

Preferably, each record in the relationship database may comprise two nodes and side information, wherein two pieces of entity data respectively representing two entities are respectively stored in the two nodes, and the inter-entity relationship data representing the relationship between the two entities is stored in the side information.

Preferably, the record for one entity in the entity database may further comprise a meta information field.

The entity-related data may further comprise meta information relevant to the entity, and the meta information is information that distinguishes the entity from others.

The method may further comprise a step of: storing the meta information into the meta information field in the record for the entity in the entity database.

In this way, as core information data in the entity data, the meta information distinguishes different entities and entity data, especially different entities with the same entity name, so that the entity related information can be accurately obtained in a subsequent search for the entity.

Preferably, the entity-related data may further comprise entity category data describing the category of the entity. The method may further comprise a step of: storing a category label corresponding to the entity category data into the meta information field in the record for the entity in the entity database, as a part of the content stored in the meta information field.

Multiple pieces of entity category data and multiple category labels are correspondingly stored in a category database, the multiple pieces of entity category data are divided into a plurality of levels, and the entity category data with a lower level is subordinated to the entity category data with a higher level associated thereto.

In this way, the entity category data is stored in different levels, so that the entity-related data has a flexible storage structure and a clear classification.

Preferably, in the category database, an entity category related attribute defined for an entity category represented by each entity category data may be stored in an associated manner with the entity category data.

The step of acquiring the entity attribute data may comprise:

Obtaining, from the category database, an entity category related attribute defined for an entity category to which the entity belongs; and

acquiring, from the web page, entity attribute data describing the entity category related attribute.

In this way, the entity attribute data can be acquired in a targeted manner according to the entity category, facilitating the response to a subsequent targeted query operation. When acquiring the entity attribute data, for a particular entity, the entity attribute data can be acquired in a targeted manner according to the category to which the entity belongs, without the need for considering unrelated entity attribute data. For example, the national territorial area will not be acquired for an actor.

Preferably, entity-related data for the same entity acquired from a plurality of web pages may be integrated together; and/or

the acquired entity-related data may be converted into entity-related data represented in a standard form.

In this way, the acquired data relevant to the same entity is sorted, and entity-related data represented in different forms are normalized, avoiding the problem of storage redundancy.

Preferably, when a plurality pieces of entity attribute data acquired for the same entity attribute of the same entity are different, the entity attribute data with a higher confidence may be kept, and the entity attribute data with a lower confidence may be deleted.

In this way, the reliability and accuracy of the stored entity attribute data can be guaranteed.

According to another aspect of the present invention, a device for storing data is provided, comprising:

a data acquisition apparatus, configured to acquire entity-related data associated with entities from a web page, the data acquisition apparatus comprising:

an entity data acquisition apparatus, configured to acquire entity data representing the entities from the web page;

an attribute data acquisition apparatus, configured to acquire entity attribute data describing the entities from the web page; and

a relationship data acquisition apparatus, configured to acquire inter-entity relationship data describing a relationship between two entities from the web page;

an entity database storage apparatus, configured to store the entity data and the respective entity attribute data into an entity database in an associated manner; and

a relationship database storage apparatus, configured to store the inter-entity relationship data into a relationship database.

Preferably, a record for one entity in the entity database may comprise an entity data field and one or more variable attribute fields associated with the entity data field, and the entity database storage apparatus may comprise:

an entity data storage apparatus, configured to store the entity data into the entity data field; and

an attribute data storage apparatus, configured to store the entity attribute data into the variable attribute field.

Preferably, each record in the relationship database may comprise two nodes and side information, wherein two pieces of entity data respectively representing two entities are respectively stored in the two nodes, and the inter-entity relationship data representing the relationship between the two entities is stored in the side information.

Preferably, the record for one entity in the entity database may further comprise a meta information field.

The data acquisition apparatus may further comprise a meta information acquisition apparatus, configured to acquire meta information relevant to the entity from the web page, and the meta information is information that distinguishes the entity from others; and

the entity database storage apparatus may further comprise a meta information storage apparatus, configured to store the meta information into the meta information field in the record for the entity in the entity database.

Preferably, the data acquisition apparatus may further comprise a category data acquisition apparatus, configured to acquire entity category data describing the category of the entity from the web page.

The meta information storage apparatus may comprise a category data storage apparatus, configured to store a category label corresponding to the entity category data into the meta information field in the record for the entity in the entity database, as a part of the content stored in the meta information field.

Multiple pieces of entity category data and multiple category labels may be correspondingly stored in a category database, the multiple pieces of entity category data are divided into a plurality of levels, and the entity category data with a lower level is subordinated to the entity category data with a higher level associated thereto.

Preferably, in the category database, an entity category related attribute defined for an entity category represented by each entity category data may be stored in an associated manner with the entity category data.

The attribute data acquisition apparatus may comprise:

an entity attribute retrieval apparatus, configured to obtain, from the category database, an entity category related attribute defined for an entity category to which the entity belongs; and

an entity attribute data acquisition apparatus, configured to acquire, from the web page, entity attribute data describing the entity category related attribute.

In this way, when acquiring the entity attribute data, for a particular entity, the entity attribute data can be acquired in a targeted manner according to the category to which the entity belongs, without the need for considering unrelated entity attribute data. For example, the national territorial area will not be acquired directed at an actor.

By means of the method and device according to the present disclosure, the entity data and the attribute data of the entity are collectively stored in the entity database, and the inter-entity relationship data is separately stored in the relationship database. This data storage method avoids data storage redundancy and query aggregation, saves storage space and is convenient for query.

Furthermore, the entity data field may correspond to one or more variable attribute field entities, so that the attribute data information about the same entity is aggregated, thus avoiding the problem that a large amount of attribute information needs to be aggregated during on-line query, nor requiring a large amount of filtering and data combination and splicing operations for returned query results, thereby greatly saving query time, and further improving user experience.

### BRIEF DESCRIPTION OF THE DRAWINGS

The exemplary embodiments of the present disclosure are described in more detail in conjunction with the accompany drawings, and the above-mentioned and other objects, features and advantages of the present disclosure would become more apparent. In the exemplary embodiments of the present disclosure, the same reference numerals generally represent the same components.

FIG. 1 is a schematic flowchart of a method for storing data according to an embodiment of the present invention.

FIG. 2 is a schematic flowchart of a method for storing data according to an improved embodiment of the present invention.

FIG. 3 is a schematic flowchart of a method for storing data according to another improved embodiment of the present invention.

FIG. 4 is a schematic flowchart of an exemplary method for acquiring entity attribute data that may be employed in the present invention.

FIG. 5 is a sub-step that may be included in step S100 of FIG. 1.

FIG. 6 is a schematic block diagram of a device for storing data according to an embodiment of the present invention.

FIG. 7 is a schematic block diagram of a data acquisition apparatus of a device for storing data according to an improved embodiment of the present invention.

FIG. 8 is a schematic block diagram of a database storage apparatus of the device for storing data according to the improved embodiment of the present invention.

FIG. 9 is a schematic block diagram of a data acquisition apparatus of a device for storing data according to another improved embodiment of the present invention.

FIG. 10 is a schematic block diagram of a database storage apparatus of a device for storing data according to another improved embodiment of the present invention.

FIG. 11 is a schematic block diagram of an attribute data acquisition apparatus of the device for storing data in FIG. 1.

### DETAILED DESCRIPTION

Preferred embodiments of the present disclosure are described in more detail below with reference to the accompany drawings. Although the preferred embodiments of the present disclosure are presented in the drawings, it should be understood that the present disclosure can be implemented in various forms and should not be limited by the embodiments set forth herein. On the contrary, these embodiments are provided to make the present disclosure more thorough and complete, and to fully convey the scope of the present disclosure to a person skilled in the art.

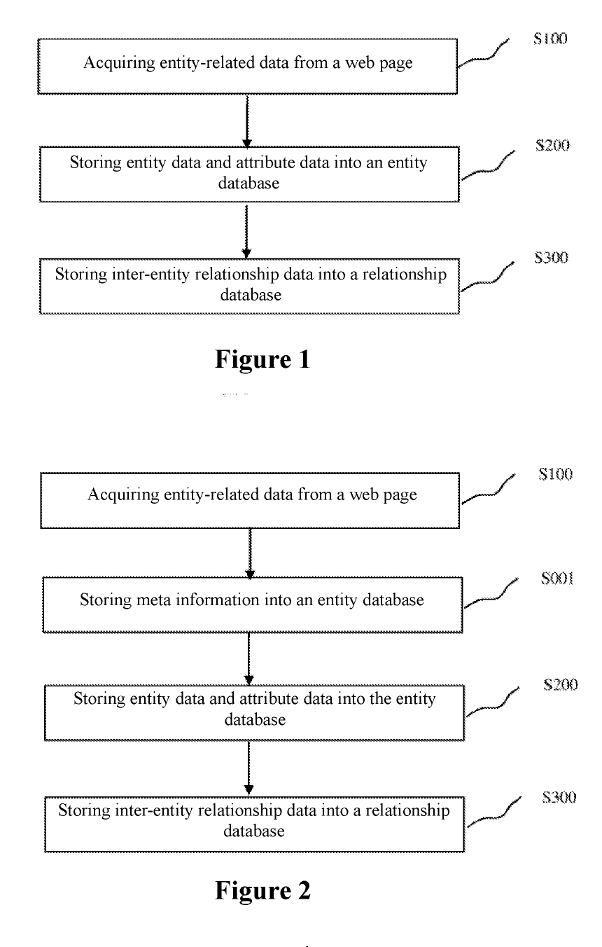

FIG. 1 is a schematic flowchart of a method for storing data according to an embodiment of the present invention.

Firstly, in step S100, entity-related data associated with entities is acquired from a web page, wherein the entity-related data may comprise at least entity data representing the entities, entity attribute data describing attributes of the entities, and inter-entity relationship data describing a relationship between two entities.

The entity data and the entity attribute data may be obtained by extracting according to a web page template, and the inter-entity relationship data may be obtained by means of link mining between pages.

In step S200, the entity data and the respective entity attribute data acquired in step S100 are stored. The entity data and the respective entity attribute data are stored into an entity database in an associated manner; and a record for one entity in the entity database comprises an entity data field and one or more variable attribute fields associated with the entity data field, wherein the entity data is stored into the entity data field, and the entity attribute data is stored into the variable attribute field.

In this way, the entity data field is stored with respect to one or more variable attribute fields associated with the above-mentioned entity data field, so that the attribute data information about the same entity is integrated and stored, thus avoiding the problem that a large amount of attribute information needs to be aggregated during on-line query, nor requiring a large amount of filtering and data combination and splicing operations for returned query results, thereby greatly saving query time, and further improving user experience.

For example, Dehua Liu is one piece of entity data, then the height of Dehua Liu and the age of Dehua Liu are both entity attribute data associated with this entity; and thus the entity attribute data associated with the same entity can be combined, integrated and stored.

In step S300, the inter-entity relationship data acquired in step S100 is stored into a relationship database. Each record in the relationship database comprises two nodes and side information, wherein two pieces of entity data respectively representing two entities are respectively stored in the two nodes, and the inter-entity relationship data representing the relationship between the two entities is stored in the side information. In some embodiments, the two nodes can be divided into an ingress node and an egress node, in which entity A and entity B are respectively stored. At this time, directional relationship data is stored in the side information.

In this way, the inter-entity relationship data is stored in a relationship database different from the entity database for storing the entity data and the entity-related data. This data storage method avoids data storage redundancy and query aggregation, and saves storage space.

Furthermore, the relationship database may be composed of two nodes and side information, and may further create indexes for the two nodes and the side information respectively, so as to improve query efficiency.

For example, the materials about Dehua Liu and Liqian Zhu are acquired from a web page, and it is dug out that they are in a conjugal relation from an external link, with the height and weight data extracted from the material of Dehua Liu and the birth date and nationality data extracted from the material of Liqian Zhu, now the method for storing the entity-related data associated with the two entities is as follows:

First of all, the entity of Dehua Liu and the height and weight data are stored in the entity database, and the entity data of Dehua Liu is stored in an entity data field, and Dehua Liu's height of 174 cm and weight information of 68 kg are respectively stored in a variable attribute field 1 and a variable attribute field 2 associated with the above-mentioned entity data field.

Secondly, the entity of Liqian Zhu and the birth date and nationality data are stored in the entity database, and the entity data of Liqian Zhu is stored in an entity data field, and Liqian Zhu's birth date of Apr. 6, 1966 and nationality of Malaysia are respectively stored in a variable attribute field 1 and a variable attribute field 2 associated with the entity data field.

Moreover, the relationship between Dehua Liu and Liqian Zhu is stored in a relationship database; if Dehua Liu and Liqian Zhu are in a conjugal relation, then the entity data of Dehua Liu is stored in a node 1 of the relationship database, and the entity data of Liqian Zhu is stored in a node 2 of the relationship database; and the “conjugal” relation between the two is stored in the side information about the two entities.

Accordingly, by means of steps S100 to S300, the entity data and the attribute data of the entity are collectively stored in the entity database, and the inter-entity relationship data is separately stored in the relationship database. This data storage method avoids data storage redundancy and query aggregation, saves storage space and is convenient for query.

FIG. 2 is a schematic flowchart showing a method for storing data of an improved embodiment.

Prior to step S200, the method for storing data may further comprise step S001; wherein in step S001, the record for one entity in the entity database may further comprise a meta information field.

The entity-related data may further comprise meta information relevant to the entity, and the meta information is information that distinguishes the entity from others.

In this way, the method may further comprise a step of:

storing the meta information into the meta information field in the record for the entity in the entity database.

Here, the acquired different entities can be distinguished by means of the meta information. For example, many pieces of entity-related information about entities named “Dehua Liu” can be obtained from web pages at the same time; however, different entities are included, someone is the actor Dehua Liu, and there is also a doctor or a teacher named Dehua Liu, etc. It can be seen therefrom that the entities with the same entity name may have different entity data. The different entities can be distinguished by means of a meta information field contained.

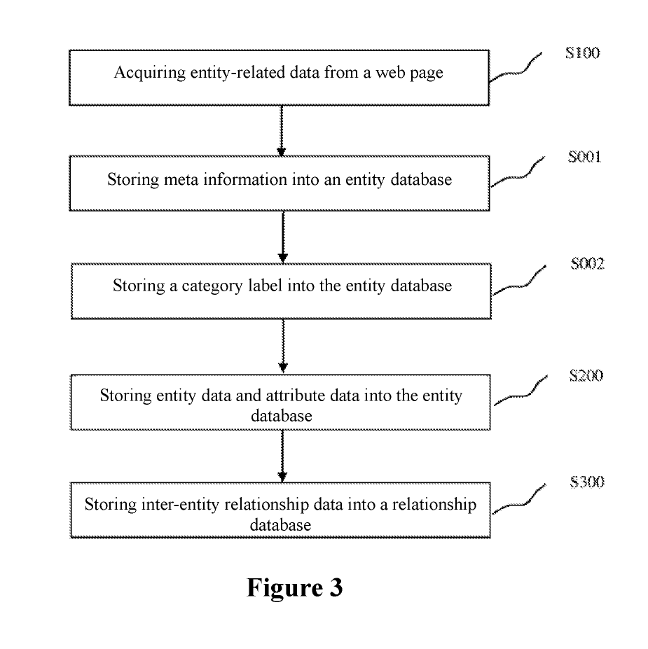

FIG. 3 is a schematic flowchart showing a method for storing data of another improved embodiment.

The entity-related data may further comprise entity category data describing the category of the entity.

In this way, the method may further comprise a step of:

storing a category label corresponding to the entity category data into the meta information field in the record for the entity in the entity database, as a part of the content stored in the meta information field.

Multiple pieces of entity category data and multiple category labels are correspondingly stored in a category database, the multiple pieces of entity category data are divided into a plurality of levels, and the entity category data with a lower level is subordinated to the entity category data with a higher level associated thereto.

Here, a category label corresponding to the data representing the entity category is stored in the meta information field; and the entity category data can be determined by different category labels in different meta information fields. In addition, with the entity category data classifying the entities, a flexible storage structure and a clear classification are achieved, thus facilitating a subsequent search by classifications.

Further, the entity category data is divided into a plurality of levels, and the entity category data with a lower level is subordinated to the entity category data with a higher level associated thereto. For example, when the category of an entity is actor, then a hypernym thereof, namely higher level of category is entertainer, and a hyponym, namely a lower level of category may be film actor, opera actor, etc. A detailed multi-level classification makes the storage format of data clearer, and the division of the storage structure more detailed, so that a subsequent accurate search is more convenient.

The above-mentioned steps S200, S300, S001 and S002 do not have to be in a specific order; and it should be understood that these steps can be carried out simultaneously, and can also be selectively conducted without a sequential order.

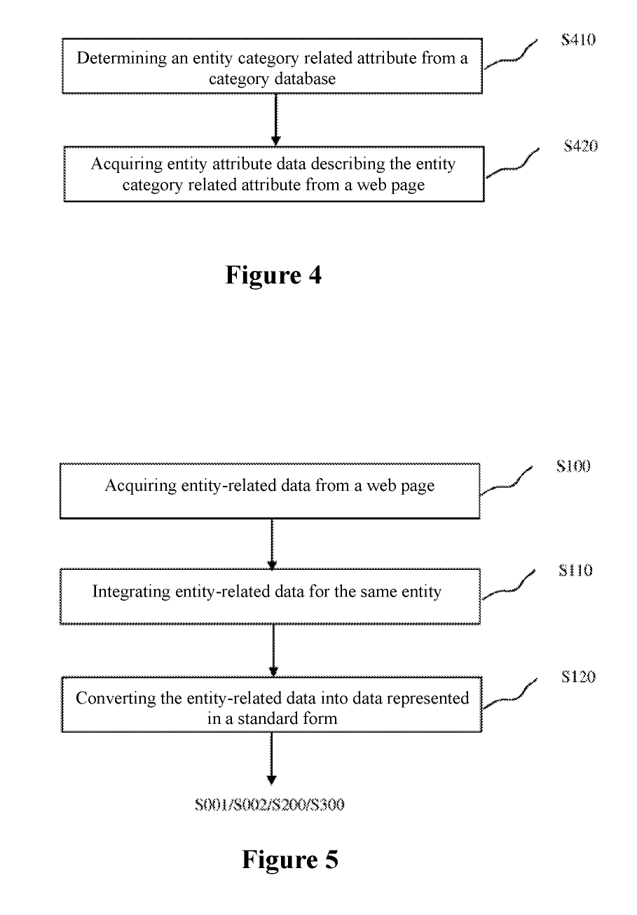

FIG. 4 is a schematic flowchart showing an exemplary method for acquiring entity attribute data that can be employed in the present invention.

In the category database, an entity category related attribute defined for an entity category represented by each entity category data is stored in an associated manner with the entity category data.

The entity attribute data can be acquired by the following steps.

Firstly, in step S410, an entity category related attribute defined for an entity category to which the entity belongs is obtained from the category database.

Next, in step S420, entity attribute data describing the entity category related attribute is acquired from the web page.

In this way, an entity category related attribute associated with an entity category to which an entity belongs can be firstly determined from the category database, and then entity attribute data describing the entity category related attribute is obtained from the web page. By acquiring different entity attribute data according to different entity categories, a discriminative acquisition and storage can be carried out, facilitating a subsequent targeted distinguishable search.

For example, an entity category represented by one piece of entity category data in the category database can be an actor, and several entity type related attributes associated with an actor are defined for the actor, such as actor type (a television actor, a film actor, a drama actor, etc.), gender, nationality and so on. Accordingly, for an entity as an actor, the entity attribute data such as the actor type, gender, and nationality thereof can be acquired from a web page and stored.

As another example, for an entity category of sports stars, entity category related attributes such as involved sports, gender, and nationality can be defined. Accordingly, for an entity as a sports star, entity attribute data related to the involved sports, gender, and nationality can be acquired from a web page and stored.

As another example, for an entity category of countries, entity category related attributes such as continent (Asia, Europe, America, Africa, Oceania), population, and territorial area can be defined. For an entity as a country, entity attribute data related to the continent, population, and territorial area can be acquired from a web page and stored.

In this way, when acquiring the entity attribute data, for a particular entity, the entity attribute data can be acquired in a targeted manner according to the category to which the entity belongs, without the need for considering unrelated entity attribute data. For example, the national territorial area will not be acquired directed at an actor.

FIG. 5 shows steps that may be further included in the method according to the embodiments of the present invention.

As shown in FIG. 5, after acquiring the entity-related data from the web page in step S100, step S110 and/or step S120 below can be executed.

In step S110, entity-related data for the same entity acquired from a plurality of web pages can be integrated together.

Here, entity-related data associated with the same entity acquired from several web pages can be sorted and integrated into related data of the same entity.

During a particular implementation, entity-related data for the same entity acquired from the web pages can be integrated; and by integrating the entity-related data acquired from different web pages at different times, the entity attribute data corresponding to the entity data may continuously increase, which is generally called “alignment” in the art. For example, the entity attribute data for the same entity and the stored entity attribute data corresponding to the same entity are integrated, and the particular integration approach may lie in adding the entity attribute data into a variable attribute field for storing the entity attribute data corresponding to the entity data, or combining the same with entity attribute data in some variable attribute field corresponding to the entity data and storing them. There are many particular integration approaches, which are described one by one in the embodiments of the present invention.

In step S120, the acquired entity-related data can be converted into entity-related data represented in a standard form.

For example, the entity-related data is uniformly represented in Chinese and in English or is standardized in units for unified processing. In this way, the problem of storage redundancy caused by the same entity-related data of the same entity occupying storage spaces is avoided; meanwhile, the problem of an unclear storage structure caused by different expression modes of the entity-related data is also avoided.

Preferably, in steps S110 and S120, when multiple pieces of entity attribute data acquired for the same entity attribute of the same entity are different, the entity attribute data with a higher confidence is kept, and the entity attribute data with a lower confidence is deleted.

After steps S110 and S120, step S001, S002, S200 or S300 can be carried out.

In this way, the reliability and accuracy of the stored entity attribute data can be guaranteed.

The method for storing data is described in detail above with reference to FIGS. 1-5. A device for storing data is described below with reference to the accompany drawings.

A number of functional analyses of the device described below are the same as those of the corresponding method steps described above with reference to FIGS. 1-5. To avoid repetition, the description herein is focused on the apparatus structure that the device is provided with, and some details may not be described any more, for which reference can be made to the relevant description above.

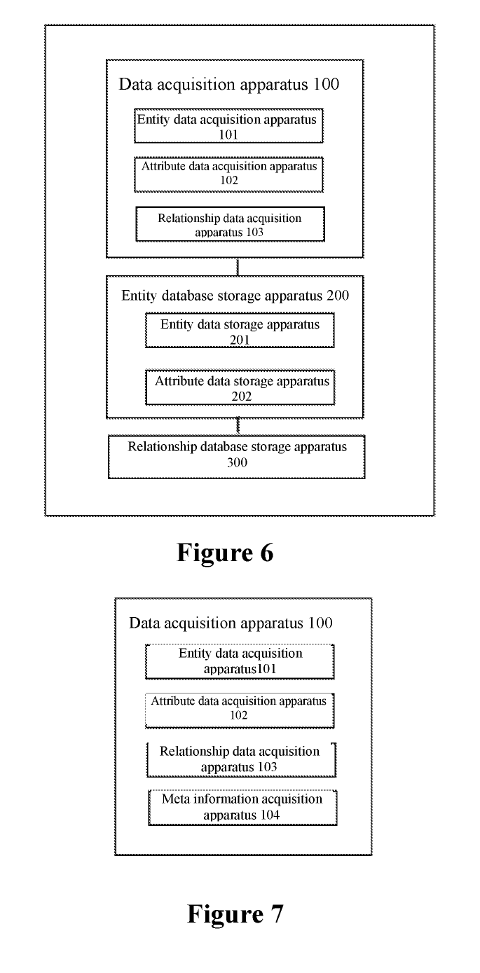

FIG. 6 is a schematic block diagram of a device for storing data according to an embodiment of the present invention.

The device for storing data according to the present invention comprises a data acquisition apparatus 100, an entity database storage apparatus 200 and a relationship database storage apparatus 300.

The data acquisition apparatus 100 is configured to acquire entity-related data associated with entities from a web page. The data acquisition apparatus may comprise:

an entity data acquisition apparatus 101 configured to acquire entity data representing the entities from the web page;

an attribute data acquisition apparatus 102 configured to acquire entity attribute data describing the entities from the web page; and

a relationship data acquisition apparatus 103 configured to acquire inter-entity relationship data describing a relationship between two entities from the web page.

The entity database storage apparatus 200 is configured to store the entity data and the respective entity attribute data into an entity database in an associated manner; and a record for one entity in the entity database comprises an entity data field and one or more variable attribute fields associated with the entity data field. The entity database storage apparatus 200 may comprise:

an entity data storage apparatus 201 configured to store the entity data into the entity data field; and

an attribute data storage apparatus 202 configured to store the entity attribute data into the variable attribute field; and

The relationship database storage apparatus 300 is configured to store an inter-entity relationship into the relationship database, wherein each record in the relationship database comprises two nodes and side information, two pieces of entity data respectively representing two entities are respectively stored in the two nodes, and the inter-entity relationship data representing the relationship between the two entities is stored in the side information.

In this way, the device can acquire entity data from the web pages via the entity data acquisition apparatus 101, acquires entity attribute data from the web pages via the attribute data acquisition apparatus 102, and acquires the inter-entity relationship data from the web pages via the relationship data acquisition apparatus 103; and then stores the entity data into the entity data storage apparatus 201, stores the attribute data into the attribute data storage apparatus 202, and separately stores inter-entity relationship data into the relationship database storage apparatus 300. This data storage method avoids data storage redundancy and query aggregation, saves storage space and is convenient for query.

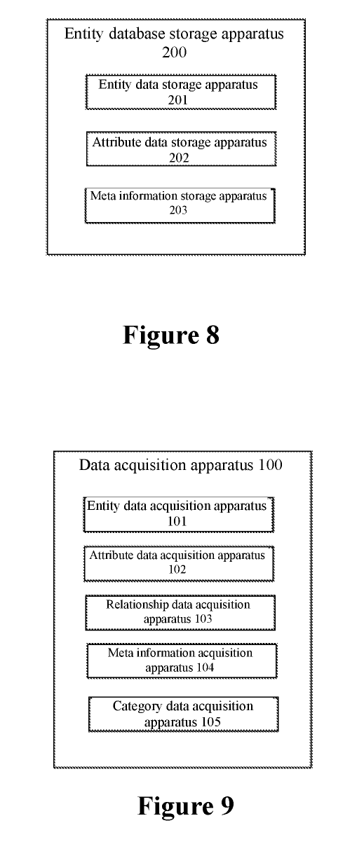

FIGS. 7 and 8 show schematic block diagrams of a database acquisition apparatus and a database storage apparatus of the device for storing data of an improved embodiment.

The record for one entity in the entity database may further comprise a meta information field.

The data acquisition apparatus 100 may further comprise a meta information acquisition apparatus 104 configured to acquire meta information relevant to the entity from the web page, and the meta information is information that distinguishes the entity from others.

The entity database storage apparatus 200 may further comprise a meta information storage apparatus 203 configured to store the meta information into the meta information field in the record for the entity in the entity database.

In this way, different entity data of the same entity name can be distinguished by the meta information acquisition apparatus 104, and different entity data of the same entity name can be stored discriminatively via the meta information storage apparatus 203.

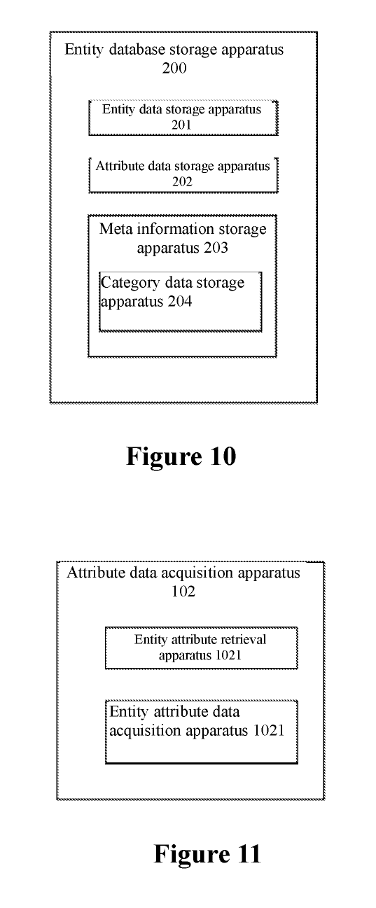

FIGS. 9 and 10 show schematic block diagrams of a database acquisition apparatus and a database storage apparatus of a device for storing data of another improved embodiment.

The data acquisition apparatus 100 may further comprise a category data acquisition apparatus 105 configured to acquire entity category data describing the category of an entity from the web page.

The meta information storage apparatus 203 may comprise a category data storage apparatus 204 for storing a category label corresponding to the entity category data into the meta information field in the record for the entity in the entity database, as a part of the content stored in the meta information field.

Multiple pieces of entity category data and multiple category labels are correspondingly stored in a category database, the multiple pieces of entity category data are divided into a plurality of levels, and the entity category data with a lower level is subordinated to the entity category data with a higher level associated thereto.

In this way, entity category data for some category is distinguished and obtained in the web pages via the category data acquisition apparatus 105, and then the corresponding category labels are distinguishably stored in the meta information field via the category data storage apparatus 204, as a part of the content stored in the meta information field.

FIG. 11 shows a schematic block diagram of an attribute data acquisition apparatus.

In the category database, an entity attribute defined for an entity category represented by each entity category data can be stored in an associated manner with the entity category data.

The attribute data acquisition apparatus 102 may comprise:

an entity attribute retrieval apparatus 1021 configured to obtain, from the category database, an entity category related attribute defined for entity category data to which the entity is subordinated; and

an entity attribute data acquisition apparatus 1022 configured to acquire, from the web page, entity attribute data describing the entity category related attribute.

In this way, an entity category related attribute associated with an entity category of some entity can be determined from a category database by the entity attribute retrieval apparatus 1021, and then entity attribute data describing the entity category related attribute is obtained from the web page by the entity attribute data acquisition apparatus 1022. Thus, when acquiring the entity attribute data, for a particular entity, the entity attribute data can be acquired in a targeted manner according to the category to which the entity belongs, without the need for considering unrelated entity attribute data.

The method and device for storing data according to the present invention have now been described in detail.

Furthermore, the method according to the present invention can also be implemented as a computer program product, which comprises a computer-readable medium on which a computer program for executing the above-mentioned functions defined in the method of the present invention is stored. It will also be appreciated by a person skilled in the art that various illustrative logic blocks, modules, circuits, and algorithm steps described in conjunction with the present invention herein can be implemented as an electronic hardware, a computer software, or a combination of both.

The flowcharts and block diagrams in the accompany drawings have shown architectures, functions and operations that may be realized with the system and method according to embodiments of the present invention. Each block in the flowchart or the block diagrams can represent a module, a program segment or a portion of a code, and the module, the program segment or a portion of the code contains one or more executable instructions for implementing specified logical functions. It should also be noted that in some alternative embodiments, the functions marked in the blocks may also take place in an order different from that marked in the drawings. For example, two successive blocks can be substantially executed in parallel in practice, and they may also be executed in an opposite order, which depends on the involved functions. It should also be noted that each block in a block diagram and/or flowchart and a combination of blocks in a block diagram and/or flowchart can be implemented with a dedicated hardware-based system for performing specified functions or operations, or can be implemented with a combination of dedicated hardware and computer instructions.

Various embodiments of the present invention have been described above, and the explanations are exemplary and not exhaustive, and the present invention is not limited to the various embodiments disclosed. Many changes and modifications would be apparent to a person of ordinary skill in the art without departing from the scope and spirit of the various embodiments explained. The selection of terms used herein is intended to best explain the principles of the various embodiments, practical applications or improvements of the techniques in the market, or to enable a person skilled in the art to understand the various embodiments disclosed herein.

1. A method for storing data for network searches, comprising:
acquiring entity-related data associated with entities from a web page, the entity-related data comprising entity data representing the entities, entity attribute data describing attributes of the entities, and inter-entity relationship data describing a relationship between two entities;
storing the entity data and the respective entity attribute data into an entity database in an associated manner; and
storing the inter-entity relationship data into a relationship database;
wherein a record for one entity in the entity database comprises an entity data field and a plurality of variable attribute fields associated with the entity data field, the entity data is stored into the entity data field, and the entity attribute data is stored into the variable attribute fields.

2. The method according to claim 1, wherein
the record for one entity in the entity database further comprises a meta information field;
the entity-related data further comprises meta information relevant to the entity, and the meta information is information that distinguishes the entity from others; and
the method further comprises:
storing the meta information into the meta information field in the record for the entity in the entity database.

3. The method according to claim 2, wherein
the entity-related data further comprises entity category data describing the category of the entity;
the method further comprises:
storing a category label corresponding to the entity category data into the meta information field in the record for the entity in the entity database, as a part of the content stored in the meta information field;
wherein multiple pieces of entity category data and multiple category labels are correspondingly stored in a category database, the multiple pieces of entity category data are divided into a plurality of levels, and the entity category data with a lower level is subordinated to the entity category data with a higher level associated thereto.

4. The method according to claim 3, wherein
in the category database, an entity category related attribute defined for an entity category represented by each entity category data is stored in an associated manner with the entity category data;
acquiring the entity attribute data comprises:
obtaining, from the category database, an entity category related attribute defined for an entity category to which the entity belongs; and
acquiring, from the web page, entity attribute data describing the entity category related attribute.

5. The method according to claim 1, further comprising:
integrating entity-related data, for the same entity, acquired from a plurality of web pages together.

6. The method according to claim 1, further comprising: converting the acquired entity-related data into entity-related data represented in a standard form.

7. The method according to claim 1, further comprising:
keeping entity attribute data with a higher confidence and deleting entity attribute data with a lower confidence when multiple pieces of entity attribute data acquired for the same entity attribute of the same entity are different.

8. The method according to claim 1, wherein
each record in the relationship database comprises two nodes and side information, wherein two pieces of entity data respectively representing two entities are respectively stored in the two nodes, and the inter-entity relationship data representing the relationship between the two entities is stored in the side information.

9. A device for storing data for network searches, comprising:
a data acquisition apparatus, configured to acquire entity-related data associated with entities from a web page, the data acquisition apparatus comprising:
an entity data acquisition apparatus, configured to acquire entity data representing the entities from the web page;
an attribute data acquisition apparatus, configured to acquire entity attribute data describing the entities from the web page; and
a relationship data acquisition apparatus, configured to acquire inter-entity relationship data describing a relationship between two entities from the web page;
an entity database storage apparatus, configured to store the entity data and the respective entity attribute data into an entity database in an associated manner; and
a relationship database storage apparatus, configured to store the inter-entity relationship data into a relationship database, wherein,
a record for one entity in the entity database comprises an entity data field and a plurality of variable attribute fields associated with the entity data field, and the entity database storage apparatus comprises:
an entity data storage apparatus, configured to store the entity data into the entity data field; and
an attribute data storage apparatus, configured to store the entity attribute data into the variable attribute fields.

10. The device according to claim 9, characterized in that
the record for one entity in the entity database further comprises a meta information field,
the data acquisition apparatus further comprises a meta information acquisition apparatus, configured to acquire meta information relevant to the entity from the web page, and the meta information is information that distinguishes the entity from others; and
the entity database storage apparatus further comprises a meta information storage apparatus, configured to store the meta information into the meta information field in the record for the entity in the entity database.

11. The device according to claim 10, wherein
the data acquisition apparatus further comprises a category data acquisition apparatus, configured to acquire entity category data describing the category of the entity from the web page,
the meta information storage apparatus comprises a category data storage apparatus, configured to store a category label corresponding to the entity category data into the meta information field in the record for the entity in the entity database, as a part of the content stored in the meta information field,
multiple pieces of entity category data and multiple category labels are correspondingly stored in a category database, the multiple pieces of entity category data are divided into a plurality of levels, and the entity category data with a lower level is subordinated to the entity category data with a higher level associated thereto.

12. The device according to claim 11, wherein
in the category database, an entity category related attribute defined for an entity category represented by each entity category data is stored in an associated manner with the entity category data,
the attribute data acquisition apparatus comprises:
an entity attribute retrieval apparatus, configured to obtain, from the category database, an entity category related attribute defined for an entity category to which the entity belongs; and
an entity attribute data acquisition apparatus, configured to acquire, from the web page, entity attribute data describing the entity category related attribute.

13. The device according to claim 9, wherein
each record in the relationship database comprises two nodes and side information, wherein two pieces of entity data respectively representing two entities are respectively stored in the two nodes, and the inter-entity relationship data representing the relationship between the two entities is stored in the side information.

14. A data storage device comprising a processor, a memory, a bus and a communication interface, wherein the processor, the communication interface and the memory are connected via the bus, and the memory stores a program, when executed by the processor, causes the data storage device to perform a method comprising:
acquiring entity-related data associated with entities from a web page, the entity-related data comprising entity data representing the entities, entity attribute data describing attributes of the entities, and inter-entity relationship data describing a relationship between two entities;
storing the entity data and the respective entity attribute data into an entity database in an associated manner; and
storing the inter-entity relationship data into a relationship database;
wherein a record for one entity in the entity database comprises an entity data field and a plurality of variable attribute fields associated with the entity data field, the entity data is stored into the entity data field, and the entity attribute data is stored into the variable attribute fields.

15. The data storage device of claim 14, wherein:
the record for one entity in the entity database further comprises a meta information field;
the entity-related data further comprises meta information relevant to the entity, and the meta information is information that distinguishes the entity from others; and
the method further comprises:
storing the meta information into the meta information field in the record for the entity in the entity database.

16. The data storage device of claim 14, wherein the method further comprises:
integrating entity-related data, for the same entity, acquired from a plurality of web pages together.

17. The data storage device of claim 14, wherein the method further comprises:
converting the acquired entity-related data into entity-related data represented in a standard form.

18. The data storage device of claim 14, wherein the method further comprises:
keeping entity attribute data with a higher confidence and deleting entity attribute data with a lower confidence when multiple pieces of entity attribute data acquired for the same entity attribute of the same entity are different.

19. The data storage device of claim 14, wherein
each record in the relationship database comprises two nodes and side information, wherein two pieces of entity data respectively representing two entities are respectively stored in the two nodes, and the inter-entity relationship data representing the relationship between the two entities is stored in the side information.
